(19) United States
(12) Patent Application Publication
(10) Pub. No.: US 2015/0022043 A1
(43) Pub. Date: Jan. 22, 2015

(54) ELECTRIC MOTOR

(71) Applicants: Martin Hoffmann, Zweibruecken (DE); Gerhard Huth, Hohenroth-Leutershausen (DE)

(72) Inventors: Martin Hoffmann, Zweibruecken (DE); Gerhard Huth, Hohenroth-Leutershausen (DE)

(73) Assignee: SIEMENS AKTIENGESELLSCHAFT, München (DE)

(21) Appl. No.: 14/381,131

(22) PCT Filed: Feb. 28, 2012
(86) PCT No.: PCT/EP2012/053340

§ 371 Date: Aug. 26, 2014

(51) Int. Cl. H02K 16/04; H02K 1/27

(52) U.S. Cl. CPC H02K 16/04; H02K 1/278; H02K 1/2786
USPC 310/156.43; 310/198

(57) ABSTRACT

A rotor in an electric motor has a plurality of permanent magnets arranged along a circumferential direction. The electric motor has a stator arrangement with a winding arrangement which surrounds, at least in parts, the permanent magnets. The stator arrangement includes a first stator having a plurality of windings and a second stator. The windings of the first and second stators are embodied, respectively, as frame-shaped coils arranged along the winding axis thereof in the radial direction. The coils of the first stator are arranged in the radial direction on the outside of the permanent magnets and the coils of the second stator are arranged in the radial direction inside the permanent magnets.

### CROSS REFERENCE TO RELATED APPLICATIONS

This application is the U.S. national stage of International Application No. PCT/EP2012/053340, filed Feb. 28, 2012 and claims the benefit thereof which is incorporated by reference herein in its entirety.

### BACKGROUND

Described below is an electric motor having a rotor with a plurality of permanent magnets arranged along a peripheral direction and having a stator arrangement with a winding arrangement that encompasses the permanent magnet at least in parts.

Electric motors in the form of small drives that have a low energy consumption are becoming ever more important. By way of example, small pump drives and fan drives in automation devices are one area of application for small drives of this type. Furthermore, small drives of this type are often used in medical technology. The development of small drives generally relates to the maximum occurring drive parameters. However, these small drives are typically operated in the so-called partial load range. The drive function for the above mentioned applications of these small drives is integrated in terms of a mechatronic system directly into the process. The electric motor becomes in this case an integrated installation component.

In addition to these structural boundary conditions, these small drives are to be embodied in such a manner that it is possible to vary the rotational speed. The drive can thus be embodied by way of example in such a manner that it is inverter-driven and includes an intermediate voltage circuit having a pulse inverter. In the case of transportable devices, it is in addition possible to replace the intermediate voltage circuit with a direct current voltage source, by way of example a battery. Applications in particular in medical technology typically require electric motors that can provide a high magnitude of torque and at the same time are light in weight, have a high level of energy efficiency, heat up only slightly and are very quiet when running.

In order to achieve this, permanently excited alternating current voltage servo motors are used nowadays in conjunction with a pulse inverter. In the case of these electrical motors, the stators may be embodied with a wound lamination stack, so that, as the rotational speed increases, the magnetization losses and accordingly the iron losses increase in an ever more dominant manner. Particularly in the partial load operation, the iron losses that are virtually independent of the load lead to a considerable impairment of the energy efficiency. In addition, the active parts of electric motors of this type typically have components of iron that represent an undesired weight component and can lead to detent torque.

EP 1 858 142 A1 discloses a linear motor that includes a secondary part having permanent magnets and includes a moving primary part having multi-phase windings through which current flows. In order to increase the achievable driving forces, the permanent magnets are arranged in such a manner that their north poles and south poles are arranged in the direction of movement one behind the other of the same pole type. In addition, the coils of the multi-phase windings are embodied in such a manner that they encompass the permanent magnets of the secondary part at least in parts.

The principle of the linear motor that is described in EP 1 858 142 A1 can likewise be applied to a rotary motor. The rotor has a plurality of permanent magnets that are arranged in the peripheral direction. The stator has a winding arrangement that encompasses the permanent magnets at least in parts. For this purpose, the stator has, by way of example, coils that are curved in a U-shaped manner. However, it is very costly to manufacture these coils in particular in the case of small rotor diameters.

### SUMMARY

Described below is an electric motor of the type mentioned in the introduction that can be operated in an energy efficient manner and can be manufactured in a simple and cost-effective manner.

The electric motor includes:
a rotor that has a plurality of permanent magnets that are arranged along a peripheral direction,
a stator arrangement that has a winding arrangement that encompasses the permanent magnets at least in parts, wherein
the stator arrangement includes a first stator having a plurality of windings, and the stator arrangement includes a second stator,
the windings of the first stator and of the second stator are embodied in each case as frame-shaped coils,
the coils of the first stator are arranged in the radial direction lying on the outside with respect to the permanent magnets,
the coils of the second stator are arranged in the radial direction lying on the inside with respect to the permanent magnets, and
the coils are arranged in the radial direction along their winding axis.

The electric motor has a rotor, wherein the permanent magnets are arranged one adjacent to the other along the peripheral direction of the electric motor. The rotor can be coupled to a corresponding shaft at which it is possible to tap the torque of the electric motor. Furthermore, the electric motor has a first outer-lying stator and a second inner-lying stator. The first stator and the second stator have corresponding windings in the form of coils that are arranged in each case one adjacent to the other in the peripheral direction. Consequently, the permanent magnets are encompassed in the rotor on two sides by the coils. It is consequently possible to generate a high magnetic force.

The electric motor can also be embodied in such a manner that it has only one outer-lying stator or only one inner-lying stator having the associated coils. As an alternative thereto, the electric motor can include, in addition to the coils of the first stator and of the second stator, further coils that encompass the permanent magnets at least in parts.

The coils of the first stator and of the second stator are essentially of a frame-shaped design. The coils include a wire winding and are embodied in particular as air-core coils, wherein they are arranged in the electric motor in such a manner that they are arranged in the radial direction along their winding axis. In other words, the coils have through-going openings along which the coils are arranged in the radial direction of the electric motor. These coils can be manufactured in a simple manner as a separate component and can be arranged in the electric motor. This type of coils is suitable in particular for use in electric motors that have a small diameter and/or for small electric drives. Consequently, the electric motor does not require any grooves or an iron yoke. As a consequence, frequency-dependent magnetization losses do not occur. Furthermore, detent torque that is caused by fluctuations in the magnetic conductivity of the stator does not occur.

The permanent magnets may be arranged in such a manner that north poles of adjacent-lying permanent magnets lie opposite one another and south poles of adjacent-lying permanent magnets lie opposite one another. It is possible by virtue of such an arrangement of permanent magnets to achieve a compact construction in a simple manner. In addition, the permanent magnets can be manufactured as individual parts in a simple and cost-effective manner and, in addition, it is possible to achieve a simple construction of the electric motor.

In one embodiment, the coils, in a direction perpendicular to the winding axis, have a greater spatial extension than in the direction of the winding axis. In other words, the respective coils in the first stator and in the second stator have a planar construction. The coils are embodied in particular as planar coils. The coils, in the direction perpendicular to the winding axis, have a large as possible spatial extension. Consequently, it is possible for the coils to generate an increased force effect on the permanent magnets. In particular, the coils are to be embodied in such a manner that the ratio is reduced between the electrical power that is introduced into the winding and the mechanical power that is output by the electric motor. Consequently, it is possible by virtue of making greater use of the electromagnetic power to generate a greater force and a greater torque whilst maintaining a constant current density. In this manner, it is possible to provide a high magnitude of torque using the electric motor.

In one embodiment, the coils in the first stator and/or in the second stator have a curvature along the peripheral direction of the electric motor. The coils of the second stator can have a greater curvature in the peripheral direction than the coils of the first stator. By virtue of the curvature of the coils in the peripheral direction, the electrical field of the coils and the magnetic field that is generated by the permanent magnets of the rotor are arranged in a perpendicular manner with respect to one another. Consequently, it is possible to generate a very high force component in the peripheral direction, as a consequence of which it is possible to generate a high magnitude of torque using the electric motor.

In a further embodiment, a number of windings and/or a cross-sectional area of a wire of the windings of the coils in the first stator differ from a number of windings and/or a cross-sectional area of a wire of the windings of the coils in the second stator. Consequently, the electrical field that is generated by the coils can be adapted in a simple manner in dependence upon the number of windings and/or upon the cross-section of the wire. Likewise, the number of windings and/or the cross-section of the wire of the coils in the first stator and in the second stator can be adjusted to suit the electrical current with which the coil is being influenced.

The permanent magnets may essentially have a shape of a hollow cylinder segment. If the electric motor is embodied as a linear motor, it is possible to use rectangular-shaped permanent magnets. Permanent magnets that have a geometric shape of this type can be manufacture in a simple and cost-effective manner. Likewise, the permanent magnets may have a cylindrical shape. In addition, it is feasible that the permanent magnets have a curvature in the peripheral direction. This renders it possible to manufacture the electric motor in a simple and cost-effective manner.

The number of coils of the first stator and of the second stator may be a multiple of three. A coil of the first stator and a coil of the second stator that are arranged aligned with respect to one another in the radial direction of the electric motor are electrically connected in series. As an alternative thereto, a coil of the first stator can be electrically connected in parallel to a coil of the second stator, as a result of which equal magnitudes of voltages are induced in the first stator and in the second stator. The direction of the electrical current that is to be applied in a rectified manner in a coil of the first stator and in a coil of the second stator, the coils being allocated to the identical winding segment. Consequently, it is possible to operate the coils in a simple manner using a three phase voltage supply.

In one embodiment, the first stator and/or the second stator have a carrier structure having a plurality of carrier elements that are embodied for the purpose of winding the coils. The carrier elements provide a type of winding aid. Consequently, the first stator and the second stator are manufactured in a simple manner.

The carrier structure and the carrier elements may be manufactured from an electrically insulating material, in particular from a material that has a relative permeability of one. The electrically insulating material around which the coils and/or the windings are arranged does not cause any eddy current losses. Consequently, it is possible to achieve a particularly energy efficient operation of the electric motor. If a material that has a relative permeability of μᵣ=1 is used, cyclic magnetization losses also do not occur.

The above described principle of the electric motor and also its advantages and further developments can likewise be applied to a linear motor.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic perspective view of an arrangement of permanent magnets of a rotor and of an arrangement of coils of a first stator of an electric motor;

FIG. 2 is a view of an arrangement of the permanent magnets and coils in a winding;

FIG. 3 is a cut-away lateral view of the electric motor;

FIG. 4 is a plan view of the electric motor;

FIG. 5 is a perspective view of the electric motor;

FIG. 6 is a lateral view of the second stator and of the rotor of the electric motor;

FIG. 7 is a perspective view of an arrangement of the coils of the first stator and of the second stator; and

FIG. 8 is a plan view of a carrier structure of the second stator.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

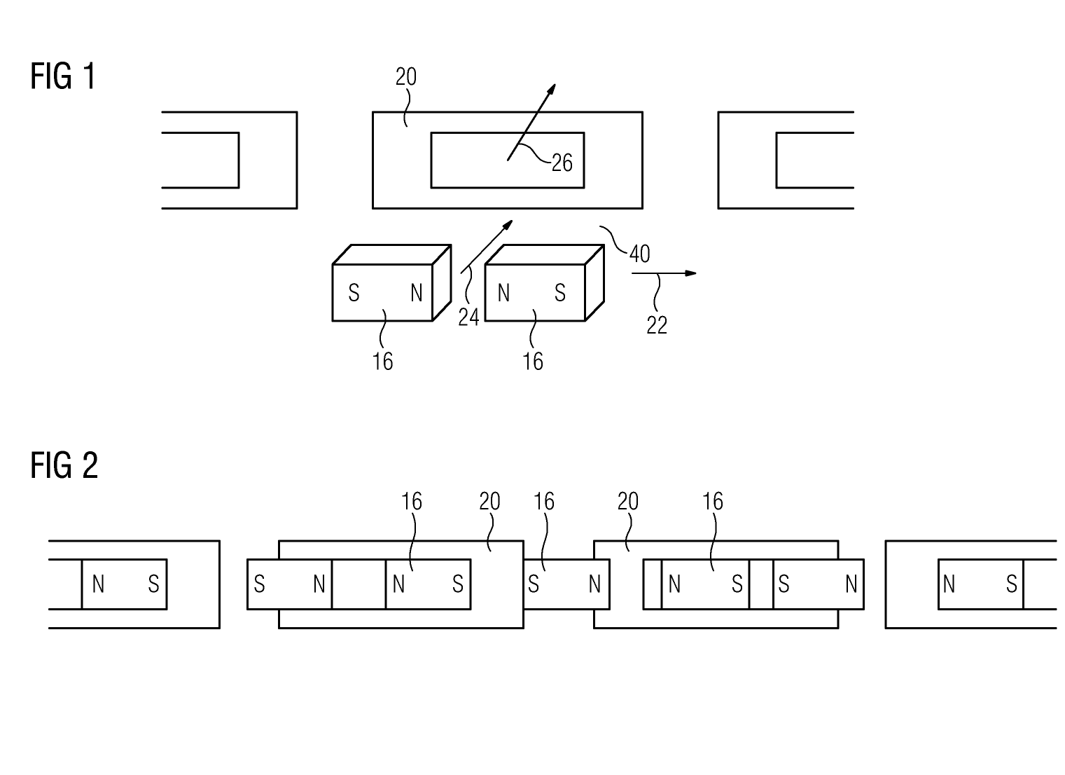

FIG. 1 illustrates in a schematic perspective view the arrangement of permanent magnets 16 of a rotor in relation to the coils 20 of a first stator or an electric motor. The permanent magnets 16 have a rectangular shape. The permanent magnets 16 are arranged adjacent to one another along the peripheral direction 22, wherein the north poles N of adjacent permanent magnets 16 lie opposite one another and the south poles S of adjacent permanent magnets 16 lie opposite one another. The coils 20 of the first stator are essentially of a frame-shaped design. The coils 20 are arranged in the radial direction 24 lying on the outside with respect to the permanent magnets 16. In addition, the coils 20 are arranged in such a manner that their winding axes 26 are arranged in the radial direction 24 of the electric motor.

FIG. 2 illustrates the arrangement of permanent magnets 16 and coils 20 in a winding. The electric motor is embodied in such a manner that the number N* of the coils 20 is a multiple of the number three. Consequently, it is possible to connect the coils 20 to a three phrase voltage supply. Consequently, an electric motor is embodied that has the basic number of poles 2p. The following principles apply:

The number of frame-shaped coils N* must be divisible by three:

$${N}^{*} = \frac{3 \cdot p \cdot z}{n}$$

For the quotient of the constant p/n, p/n must be a whole number, wherein in addition n≠3, 6, 9, . . . must apply.

If z is an even number, then each winding phase includes 2p/n coil groups per each z/2 frame-shaped coils.

In the present case, the above mentioned principles are represented for a 10-pole embodiment of the electric motor. As a consequence, the basic number of poles is 2p=10. This produces from the quotient of the constant z/n=2/5. Each winding side then includes

$${N}^{*} = \frac{3 \cdot p \cdot z}{n} = \frac{3 \cdot 5 \cdot 2}{5} = 6$$

frame-shaped coils. Each of the three winding phases include 2p/n=10/5=2 coil groups having each z/2=2/2=1 frame-shaped coils.

FIGS. 1 and 2 illustrate in each case the arrangement of the permanent magnets 16 and the coils 20 of an electric motor that has a first outer-lying stator. The electric motor also may have a second inner-lying stator wherein the coils are arranged in the radial direction 24 lying on the inside with respect to the permanent magnets 16.

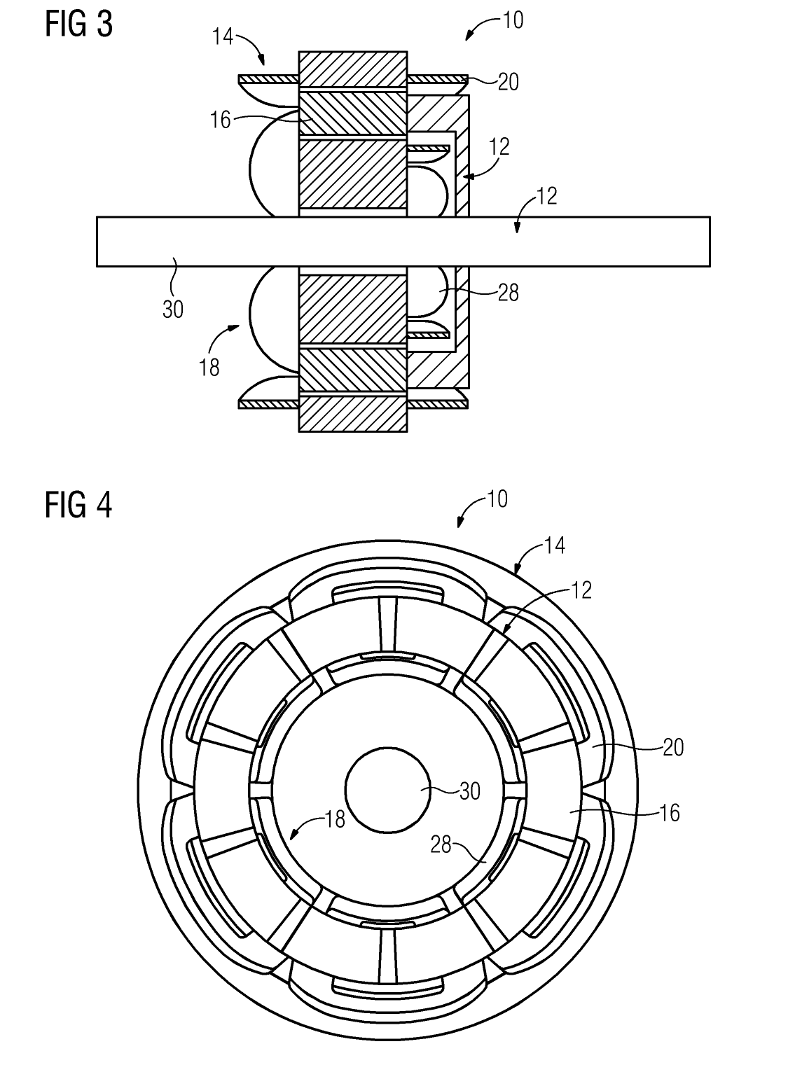

FIG. 3 is a cut-away lateral view an electric motor 10 that has 10 poles. The electric motor 10 has a rotor 12 that is connected in a mechanical manner to a shaft 30. In addition, the rotor 12 has a plurality of permanent magnets 16 that are arranged on a radial disc and an axial hollow cylinder. Furthermore, the electric motor 10 has a first stator 14 having a plurality of coils 20. In addition, the electric motor also has a second stator 18 having a plurality of coils 28. The coils 20 of the first stator 14 and the coils 28 of the second stator have a curvature in the peripheral direction 22 of the electric motor 10. Likewise, the permanent magnets can have a curvature along the peripheral direction 22.

FIG. 4 is a plan view of the electric motor 10 in accordance with FIG. 3. The rotor 12 of the electric motor is evident and the rotor includes 10 permanent magnets 16. In addition, the first stator 14 is illustrated and the stator has six coils 20. The coils 20 of the first stator 14 are arranged in the radial direction 24 of the electric motor 10 lying on the outside with respect to the permanent magnet 16 of the rotor 12. Likewise, the second stator 18 has six coils 28. The coils 28 of the second stator 18 are arranged in the radial direction 24 lying on the inside with respect to the rotor 12.

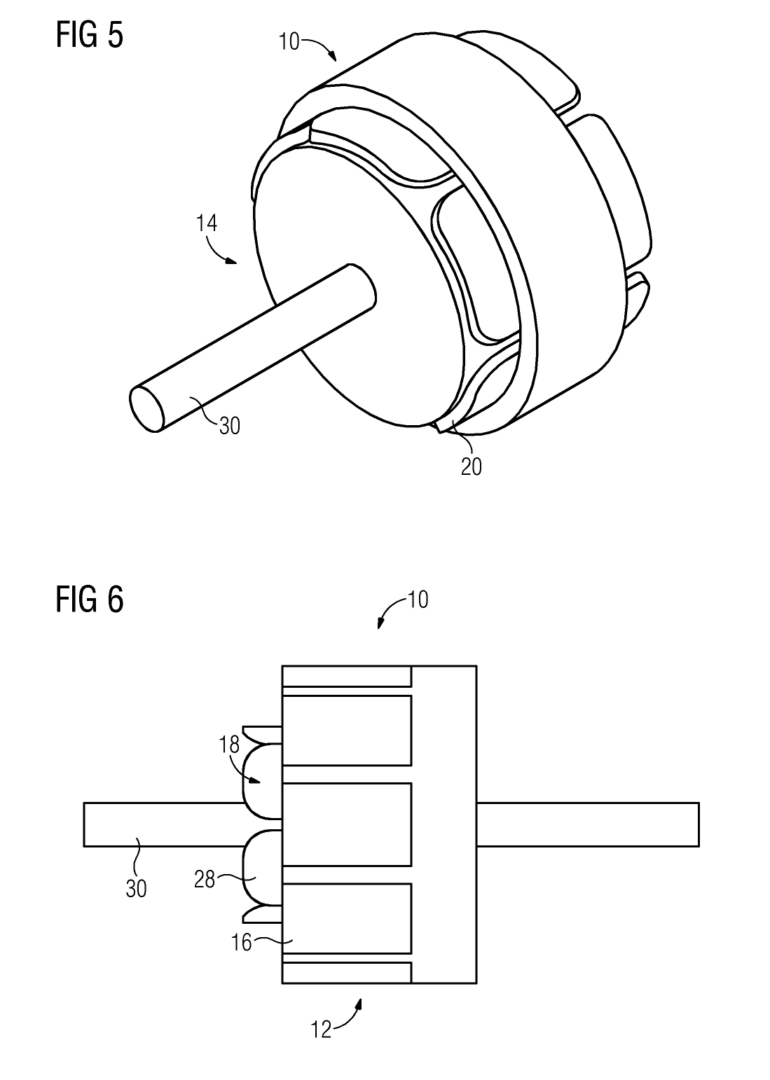

FIG. 5 is a perspective view of the electric motor 10 from the lower face. In particular, the coils 20 of the first stator 14 are evident. FIG. 6 is a partial view of the electric motor 10 without the first stator 14. The rotor 12 of the electric motor 10 having the permanent magnets 16 is evident. Furthermore, the coils 28 of the second stator 14 are illustrated.

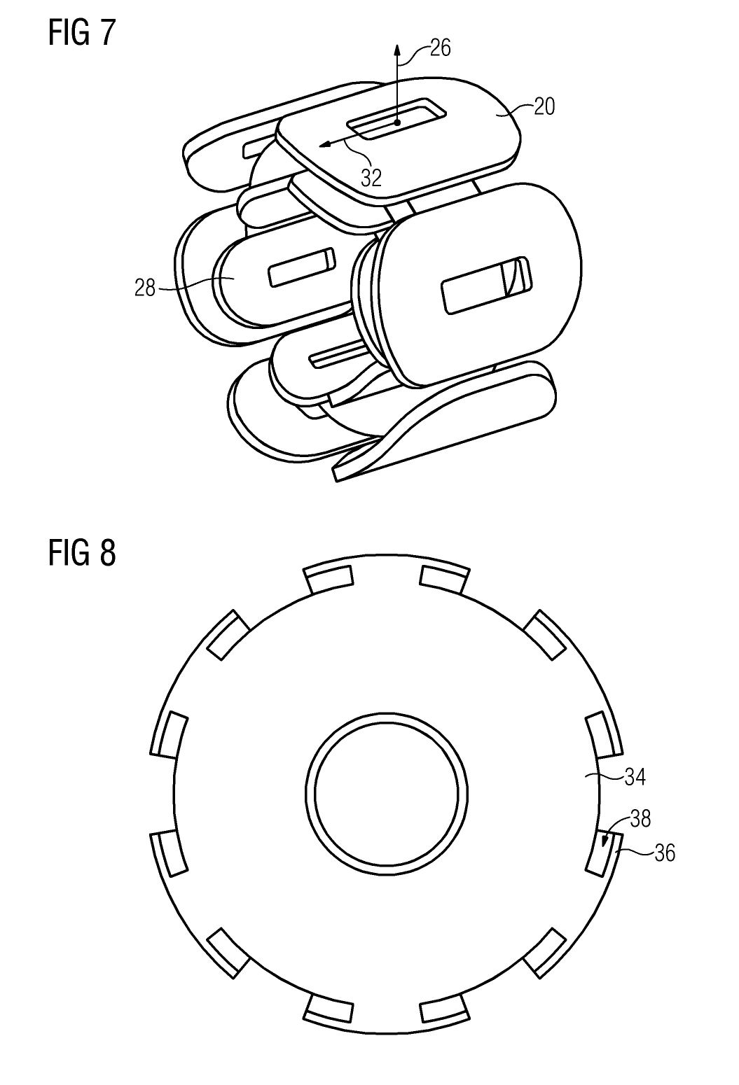

FIG. 7 is a perspective view of the arrangement of the coils 20 of the first stator 14 and the coils 28 of the second stator 18. The coils 20, 28 in each case have an essentially frame-shaped structure. The coils 20, 28 are produced by a wound wire and consequently form a corresponding air-core coil. The coils have a smaller spatial extension along the winding axis 26 than in a direction 32 that is perpendicular to the winding axis 26. In other words, the coils 20, 28 have a planar construction. In particular, the coils 20, 28 are to be embodied in such a manner that the ratio is reduced between the electrical power that is introduced into the winding and the mechanical power output. Consequently, it is possible to produce a greater force and a greater torque whilst maintaining a constant current density.

Furthermore, the coils 20, 28 are curved along the peripheral direction of the electric motor 10. As is illustrated in FIG. 7, the number of windings of the coils 20, 28 can differ. The coils 28 of the second stator 18 have in this case a lower number of windings than the coils 20 of the first stator 14. The cross-sectional area of the wires of the coils 20 of the first stator 14 in comparison to the cross-sectional area of the wires of the coils 28 in the second stator 18 can be embodied differently.

FIG. 8 is a plan view of the carrier structure 34 of the inner stator 18. The carrier structure 34 has a plurality of carrier elements 36. The carrier elements 36 are embodied by a protrusion in the radial direction and the protrusion has a two-sided cut-out 38. It is possible to introduce the wire into this cut-out 38 and this consequently enables the respective coils 28 to be wound. The carrier structure 34 and the carrier elements 36 may be embodied from an electrically insulating material that has in particular a relative permeability of one.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-9. (canceled)

10. An electric motor, comprising:
a rotor with a plurality of permanent magnets arranged along a peripheral direction of the electric motor; and
a stator arrangement, having a winding arrangement that encompasses the permanent magnets at least in parts, including first and second stators, each having a plurality of windings embodied in each case as frame-shaped coils arranged in a radial direction along a winding axis, the coils of the first stator arranged in the radial direction lying outside of the permanent magnets and the coils of the second stator arranged in the radial direction lying inside the permanent magnets.

11. The electric motor as claimed in claim 10, wherein north poles of adjacent permanent magnets lie opposite one another and south poles of adjacent permanent magnets lie opposite one another.

12. The electric motor as claimed in claim 11, wherein the coils have a greater spatial extension in a first direction perpendicular to the winding axis than in a second direction of the winding axis.

13. The electric motor as claimed in claim 12, wherein the coils in at least one of the first and second stators have a curvature along the peripheral direction of the electric motor.

14. The electric motor as claimed in claim 13, wherein a number of windings and/or a cross-sectional area of a wire of windings of the coils in the first stator differs from a number of windings and/or a cross-sectional area of a wire of the windings of the coils in the second stator.

15. The electric motor as claimed in claim 14, wherein the permanent magnets comprise essentially a shape of a hollow cylinder segment.

16. The electric motor as claimed in claim 15, wherein the coils in each of the first and second stator number a multiple of three.

17. The electric motor as claimed in claim 16, wherein at least one of the first and second stators comprises a carrier structure having a plurality of carrier elements on which the windings of the coils are wound.

18. The electric motor as claimed in claimed in claim 17, wherein the carrier structure and the carrier elements are formed of an electrically insulating material.

19. The electric motor as claimed in claimed in claim 17, wherein the electrically insulating material of the carrier structure and the carrier elements has a relative permeability of one.
